(19) United States
(12) Patent Application Publication
(10) Pub. No.: US 2009/0218882 A1
(43) Pub. Date: Sep. 3, 2009

(54) Tracks For Track Laying Vehicles And Vehicles Carrying Such Tracks

(75) Inventors: Jim Rowbottom, Washington (GB); Paul Gibson, Durham (GB)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: ASTRUM (UK) LIMITED, BISHOP AUCKLAND (GB)

(21) Appl. No.: 12/279,068

(22) PCT Filed: Feb. 12, 2007
(86) PCT No.: PCT/GB2007/000480

§ 371 Date: Feb. 17, 2009

(30) Foreign Application Priority Data
Feb. 13, 2006 (GB) 0602833.6

(51) Int. Cl. B62D 55/21; B62D 55/18

(52) U.S. Cl. 305/158; 305/185; 305/202

(57) ABSTRACT

Track sections (10) for forming into tracks for track laying vehicles are linked at one or more joints to form a continuous track. Co-operating formations (34) of respective track section ends in the joint are configured to prevent rotation of the respective track sections about the joint, so that the joint is substantially rigid.

The present invention relates to tracks for track laying vehicles and to track laying vehicles employing such tracks. The invention relates to tracks for vehicles such as armoured fighting vehicles (tanks, armoured personnel carriers and the like), agricultural vehicles, construction vehicles and the like. In particular, the invention relates to so-called band, rubber band or continuous track systems and to joints in such track systems.

### BACKGROUND

Band track systems have been known for a number of years and in their simplest form consist of a single, continuous loop of track, primarily of rubber with suitable reinforcement, which is fitted around the carrying wheels and drive mechanism of a vehicle. This construction has significant disadvantages. In particular, because the track is formed as a single continuous loop, it is difficult to fit onto a vehicle. Typically many vehicle components must be removed before the track can be fitted and it is also necessary to raise the vehicle off the ground. A track in the form of a continuous loop is also bulky and heavy, making it difficult to handle, and the scope for introducing variants of the track for use with different vehicles is limited.

Especially in military applications, the logistical difficulties in carrying large, heavy replacement tracks which are not easy to handle manually (if they can be so handled at all) are very significant. Furthermore, tracks are subject to damage by arms fire, rough or difficult terrain, mines and so on. Failure of only a small portion of a continuous track causes effective failure of the whole track and replacement in the field may not be feasible. Where this happens, vehicles become disabled in vulnerable situations.

In order to address some of these problems, it has been suggested to form the band track as a plurality of linked sections. For example, EP 0 410 216 describes a track in which individual track sections comprise longitudinally arranged flexible endless belts encased in the rubber of the track. Lateral tension members pass through end portions of the belts. The tension members are fixedly attached to (or integral with) hinge members by which individual track sections are linked together. A track pin is passed through bores in the respective hinge members to join them together and the hinge members articulate around the track pin.

The present invention seeks to provide an improved band track.

According to a first aspect of the invention there is provided a track for a track-laying vehicle comprising:
a plurality of track sections joined together at substantially rigid joints formed between the adjacent track sections, each track section comprising:
   (i) an intermediate relatively flexible portion;
   (ii) one or more first joining portions attached at one end of the track section and one or more second joining portions attached at the other end of the track section; and
   (iii) co-operating formations of a first type or a second type arranged at respective ends of the track section,
wherein in the substantially rigid joint:
   (a) the joining portions of the adjacent track sections are arranged in a predetermined mutual joining configuration; and
   (b) the co-operating formations of the first and second types arranged respectively on the adjacent track sections co-operate substantially to prevent rotation of a given track section end with respect to the track section end to which it is attached.

According to a second aspect of the invention there is provided a track section adapted to be joined to like track sections by means of substantially rigid joints to form a track for a track-laying vehicle, the track section comprising:
(i) an intermediate relatively flexible portion;
(ii) one or more first joining portions attached to the track section at one end thereof and one or more second joining portions attached to the track section at the other end thereof;
(iii) operatively co-operating formations of a first type or a second type arranged at respective ends of the track section,
wherein the respective first and second joining portions and the co-operating formations are so arranged that, when, operatively, the track section is joined to an adjacent like track section:
   the joining portions of the joined track sections are arranged in a predetermined mutual joining configuration; and
   co-operating formations of the first or second type are arranged to cooperate with respective co-operating formations of the second or first type of the adjacent like track section substantially to prevent rotation of a given track section end with respect to the track section end to which it is attached.

In a preferred embodiment of the first aspect of the invention the one or more joining portions comprise one or more track pin retaining elements, each track pin retaining element comprising a through bore, the bores of the track pin retaining elements at the respective ends being substantially coaxial, wherein in the substantially rigid joints formed between the adjacent track sections the track pin retaining elements of the adjacent track sections are so arranged that the through bores are coaxial and a track pin is disposed through the bores of each joint.

In a preferred embodiment of the second aspect of the invention the one or more joining portions comprise track pin retaining elements, each track pin retaining element comprising a through bore, the track pin retaining elements being so arranged that, when operatively the track section is joined to an adjacent like track section, the through bores of the track pin retaining elements are coaxial.

In particularly preferred embodiments of these aspects of the invention the relatively flexible intermediate portion comprises:
(iv) an inner face and an outer face, the outer face operatively contacting the ground; and
(v) one or more tension elements arranged within the track section and extending longitudinally of the track section;
and wherein one or more tension element attachment formations are arranged proximate the respective ends of the track section, to which the or each tension element is attached whereby tensile loads are operatively transferred between the tension elements and the joining portions

In one preferred embodiment the, or each, tension element comprises a wire or cable.

In a particularly preferred embodiment the, or each, tension element comprises a longitudinally extensive web of fabric. Preferably in this case the fabric is formed from a high strength fibre such as an aramid (more especially para-aramid) fibre (e.g. Kevlar™) or carbon fibre or an ultra high molecular weight polyethylene fibre, or a mixture of such fibres.

Preferably the inner and outer surfaces of the track section comprise material selected from rubber, synthetic rubber, rubber composite or synthetic rubber composite material, and rubber-like compositions and the or each tension element is substantially encapsulated in said material. Preferably the outer surface of the track section comprises gripping formations.

Preferably the tension element attachment formations comprise one or more of: outer surfaces of the joining portions; and one or more anchor members attached to joining portions at respective ends of the track section.

In preferred constructions according to the above embodiments, the joining portions are track pin retaining elements.

Preferably the anchor members comprise rod-like portions to which the tension elements are attached. The rod like portions are preferably substantially cylindrical but may, for example, be elliptical, rectangular, square or polygonal (e.g. hexagonal) in cross section.

Preferably the rod-like portions are substantially co-linear. Preferably also, where the joining portions take the form of track pin retaining elements, the rod-like portions of the anchor members are arranged substantially parallel to the axis of the through bore of the or each track pin retaining element.

In a preferred construction, the anchor members are fixedly attached to adjacent track pin retaining elements. Preferably in this construction the track pin retaining elements are attached to adjacent anchor members by means of one or more connecting webs, whereby the track pin retaining elements and the anchor members are arranged in spaced apart relation.

Preferably the or each formation of the first type is fixedly attached to an adjacent anchor member and more preferably the or each formation of the first type is formed integrally with an adjacent anchor member.

In particularly preferred embodiments of the invention each respective end of the track section comprises a unitary body which body includes both the anchor member and the joining portions (in particular, track pin retaining elements).

Preferably in the above embodiment the unitary body at a first end of the track section further includes at least one co-operating formation of the first type. Preferably also the unitary body at a second end of the track section further includes at least one co-operating formation of the second type.

In preferred embodiments of the invention the co-operating formations of the first type include an abutment surface which, on operatively forming said joint, is juxtaposed against a complementary abutment surface of a co-operating formation of the second type thereby to prevent said rotation.

Preferably the co-operating formation of the first type comprises a longitudinally projecting finger and preferably also the abutment surface comprises a leading end surface of said finger. Most preferably said abutment surface is substantially planar.

Preferably, when the joining portions take the form of track pin retaining elements, the co-operating formation of the first type includes a through bore which is coaxial with the through bore of the track pin retaining elements and is sized operatively to accommodate a track pin.

Preferably said complementary abutment surface of the co-operating formation of the second type is formed in a connecting web by which the track pin retaining elements are attached to an adjacent anchor member.

According to further aspects of the invention there is provided a vehicle having a track as defined in the first aspect of the invention, and a vehicle having a track formed from track sections as defined in the second aspect of the invention.

### BRIEF DESCRIPTION OF THE DRAWINGS

For a better understanding of the invention and to show how the same may be carried into effect reference will be made by way of example only to the following drawings in which:

FIG. 1 is a perspective view of one end of a track section according to the invention;

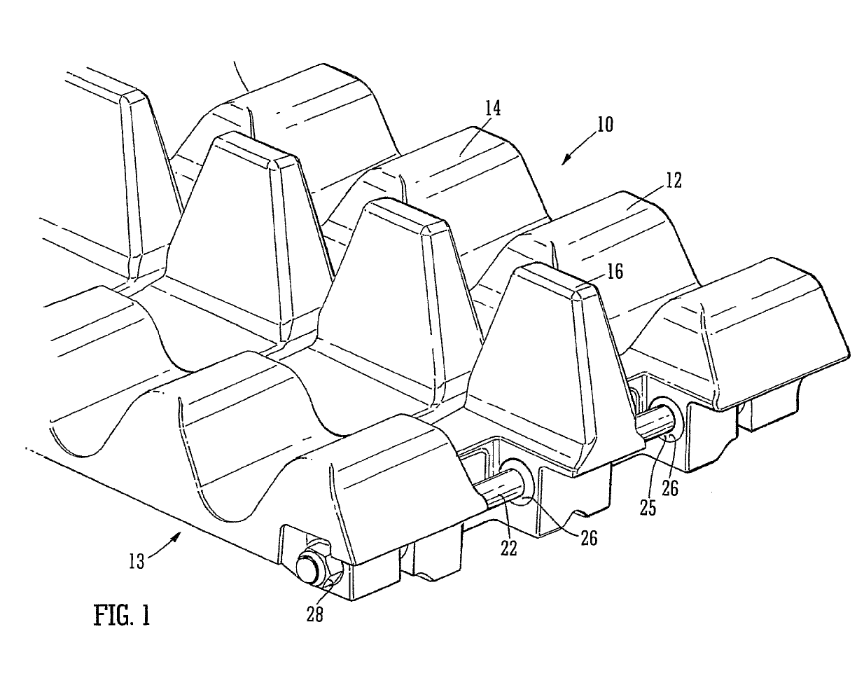

FIG. 2A is similar to FIG. 1 with part of the track section cut away;

FIG. 2B is similar to FIG. 2A and shows a variation in the arrangement of tension elements;

FIG. 3 is a perspective view of another end of a track section according to the invention;

FIG. 4A shows a track section similar to that of FIG. 3, also partially cut away; and

FIG. 4B is similar to FIG. 4A and shows a variation in the arrangement of tension elements.

### DETAILED DESCRIPTION

Referring now to the drawings, the track section 10 according to the invention comprises an inner surface 12 and an outer surface 13. The track section 10 is constructed so that it may be connected to like track sections to form a continuous track mounted on a track laying vehicle. As will be explained below, “like” track sections need not be identical. The track laying vehicle may, for example be a construction vehicle such as an earth moving vehicle, or a military vehicle such as a tank or armoured personnel carrier. The outer surface 13 is usually provided with shaped formations which provide grip for the vehicle on a range of ground surfaces and conditions. Formations 14, 16 may also be provided on inner surface 12 to assist in retaining the track on the track laying vehicle and for transferring drive, steering and braking loads between the vehicle and the ground surface. The illustrated formations 14, 16 are merely exemplary and other types, shapes and numbers of such formations may be provided in accordance with the particular design requirements of a given vehicle. The track section 10 is primarily constructed from a rubber, synthetic rubber, rubber composite or synthetic rubber composite or rubber-like material within which most of the other components of the track section 10 are embedded.

To form the vehicle track, the track sections 10 are joined together at a joint. The joints are substantially rigid, whereas the portion of the track section 10 between the joints, which will normally form the majority of the track section 10, is relatively flexible.

Each track section 10 comprises at least one tension element 18 such that tensile loads in the track are transferred between the joints and the tension elements 18. The tension element 18 most preferably comprises a web of fabric arranged longitudinally within the track section 10 and embedded in the rubber material from which the track section 10 is formed. A plurality of tension elements 18 comprising a plurality of parallel webs of fabric may be provided. However, in a preferred arrangement a single tension element 18 is provided which comprises a web of fabric which extends laterally across the majority of, and most preferably substantially the whole of, the width of the track section 10. In alternative constructions, the tension element 18 may comprise other components able to carry a tensile load, for example longitudinally arranged wires or cables embedded within the rubber material and anchored at respective ends of the track section.

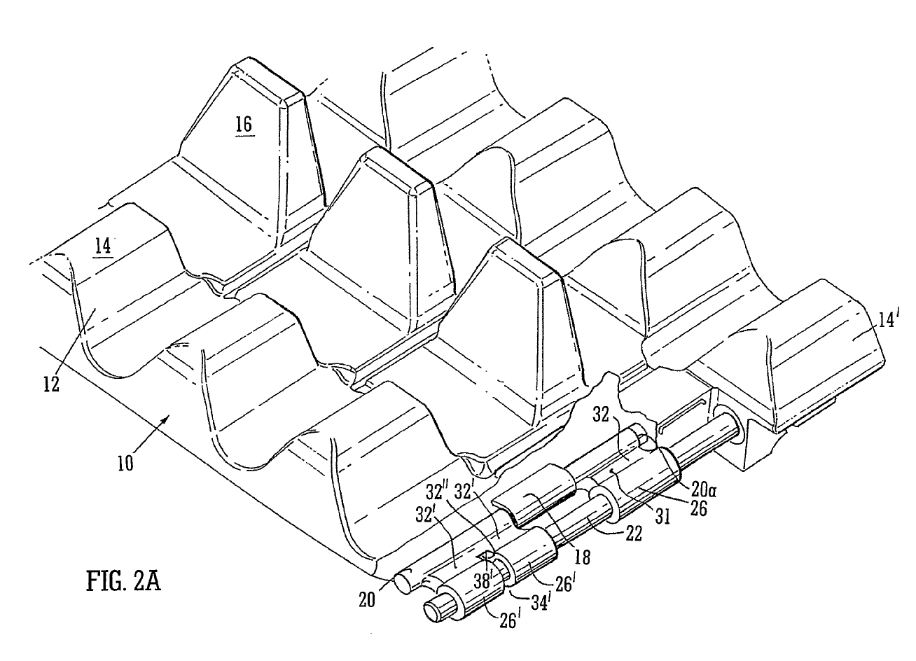

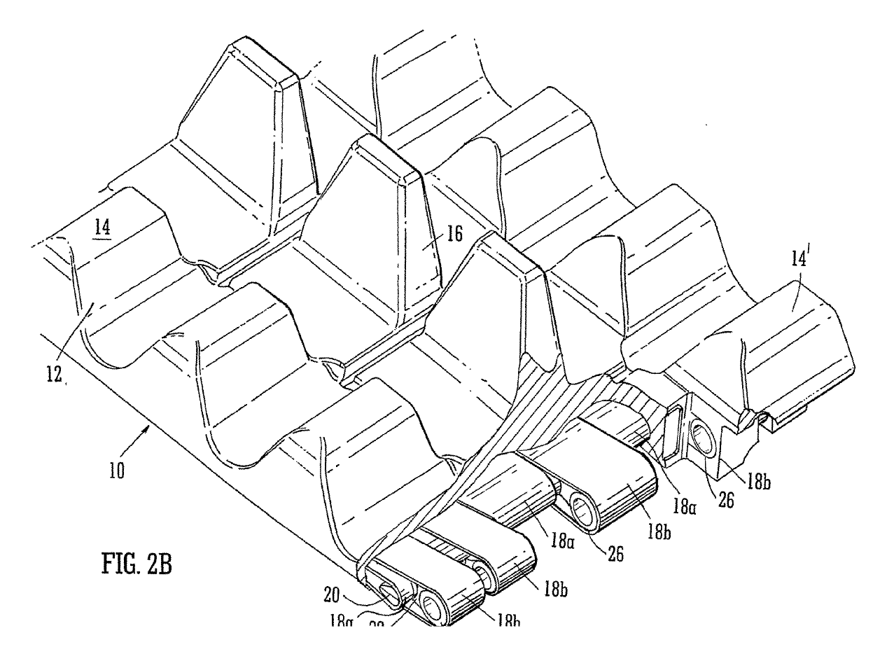

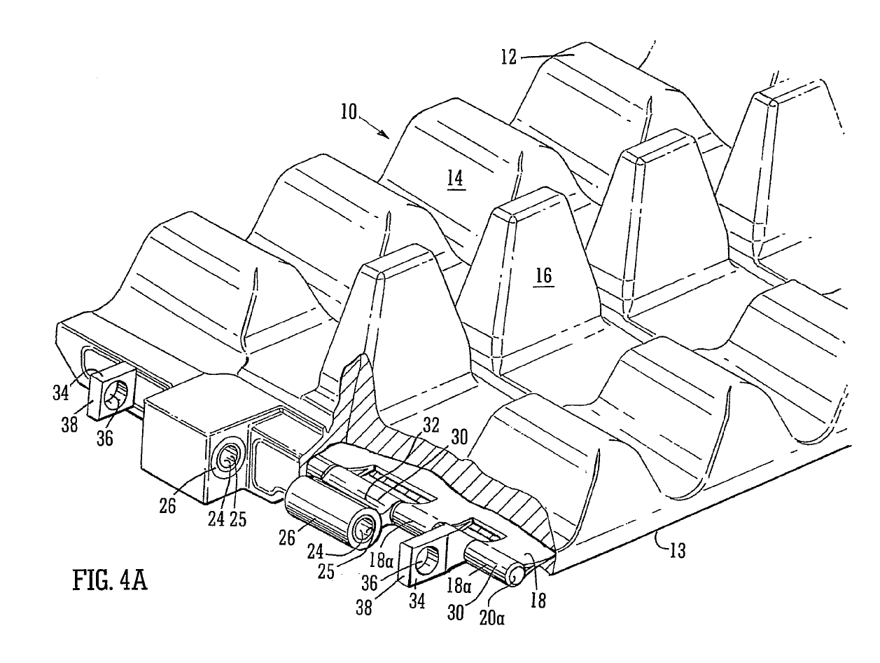

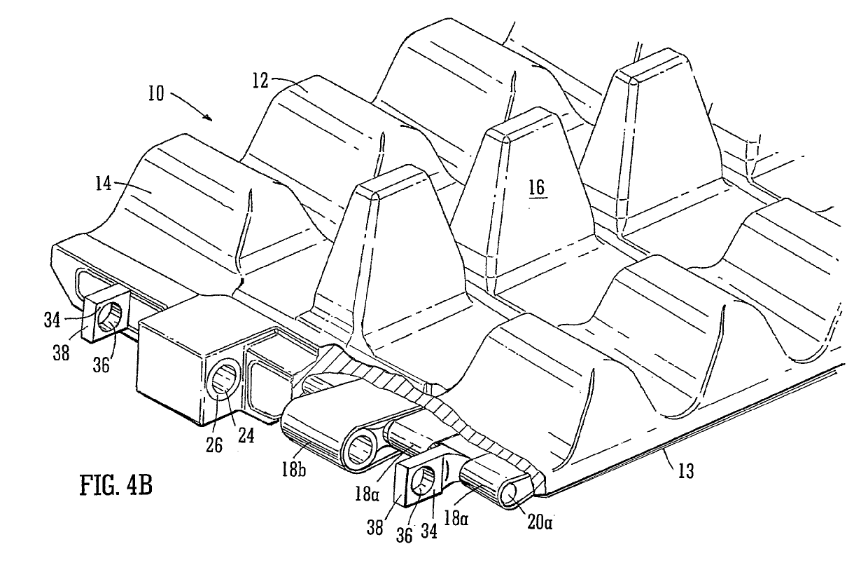

Respective ends of the track section are provided with tension element attachment formations. In the embodiment illustrated in FIGS. 2A and 4A, each end the track section 10 is provided with an anchor member 20 to which one or more tension elements 18 is (are) attached. The anchor member 20 is also embedded in the rubber material from which the track section 10 is formed. In one preferred embodiment as illustrated, the anchor member 20 includes portions 20a which are rod-like or bar-like. The rod-like sections are preferably cylindrical but may be other shapes, such as elliptical, square, rectangular, polygonal (e.g. hexagonal) or irregular in cross-section. The tension element(s) 18 is (are) provided with loops 18a by means of which the tension element 18 is attached to the anchor member 20 by passing around the rod like sections 20a. Thus, tensile loads in the track are transferred from the anchor members 20 to the tension elements 18. Anchor members 20 are fixedly attached to joining portions which most preferably take the form of track pin retaining elements 26.

A given track section 10 is joined to adjacent like track section by means of a suitable joint. In principle, any suitable means of joining the like track sections together may be used, provided that it is sufficiently robust and amenable to separation of the track sections when desired. A much preferred joint comprises a track pin 22 accommodated in suitable bores of the joint. The bores 24 are defined in track pin retaining elements 26 formed at each end of the track section 10. Track pin retaining elements 26 are also preferably embedded in the rubber material of the track section 10. Bores 24 may include bushings 25 which provide a seat for a track pin (see below) and may assist in preventing rotation of the joint about the track pin. The track pin retaining elements 26 are so arranged at each respective end of the track that the bores 24 are coaxial. Further the track pin retaining elements 26 are arranged in spaced apart relation, the position of the track pin retaining elements 26 being such that, when like track sections 10 are brought together, the track pin retaining elements 26 of a first of the like track sections lie within respective spaces defined between track pin retaining elements 26 of the second of the like track sections. In other words, the track pin retaining elements of the like track sections are arranged alternately within the joint. Preferably the size of the said space substantially corresponds to the axial width of the track pin retaining element 26 which it is intended to accommodate. The track pin retaining elements 26 of the first and second track sections 10 (when the track sections 10 are brought together) are so arranged that the bores 24 of the respective track sections 10 are coaxial, so allowing the track pin 22 to be disposed in the bores 24. The track sections 10 are thus joined together. The track pin 22 is secured in position by suitable fastening means which, in the illustrated embodiment is a nut 28.

As can be seen in particular from FIGS. 2B and 4B, in particularly preferred forms of the invention one or more tension members 18 may be provided with loops 18b by means of which the tension element 18 is attached to a track pin retaining element 26 by passing around the track pin retaining element 26. Thus, the outer surfaces of the respective track pin retaining elements 26 form tension element retaining formations and tensile loads in the track are transferred from the track pin retaining elements 26 to the tension elements 18. In the preferred arrangement, some tension elements 18 may be attached to anchor members 20 and other tension elements 18 may be attached to track pin retaining elements 26, depending on the respective location within the track section 10 of the given tension element 18. In a particularly preferred configuration, a single tension element 18 is provided which comprises a web of fabric which extends laterally across the majority of, and most preferably substantially the whole of, the width of the track 10. End portions of the tension element are divided, e.g. cut, longitudinally into a number of parallel fingers or tongues, the width of each tongue being sized to conform to the size of a respective tension element attachment formation. The tongues, depending on their particular location, pass either around an anchor member 20 or a track pin retaining element 26.

In the most preferred forms of the invention the track pin retaining elements 26 and the anchor members 20 are formed as a single unitary body 30 or 31, preferably as a single forging of metal. Other suitably strong materials may alternatively be used. The unitary body 30 or 31 is constructed so that the rod-like portions 20a are co-linear (i.e. the principal axes of the rod like portions are aligned) and are arranged substantially in parallel with the bores of the track pin retaining elements 26. The track pin retaining elements 26 and the anchor members 18 are joined in spaced relation by connecting webs or connecting portions 32. Webs 32 may be of non-uniform thickness, typically being thicker towards track pin retaining elements 26.

Each end of the track section 10 is provided with co-operating formations of a first type or a second type. The purpose of the co-operating formations is to prevent rotation of the joined track sections 10 about the track pin 22, that is, to ensure that the joint between the track sections is substantially rigid. Various configurations of the co-operating formation are possible with regard to the track section 10. Thus an end of the track section 10 may include only co-operating formations of the first type. In this case, the end of the track section may be joined to another track section end including only co-operating formations of the second type. It follows that a track section end having only co-operating formations of the second type can be joined to a track section end having only co-operating formations of the first type. Alternatively, a given track section end may include both formations of the first type and of the second type. In this case, the given track section end may be joined to another track section end having formations of both the first and second types, arranged in complementary positions.

In the preferred construction according to the invention, a track section 10 has co-operating formations of the first type at one end and co-operating formations of the second type at its other end. In this way, all track sections 10 which are joined together to form a track may be substantially identical. However, it is also possible to construct a track from track sections 10 which are like, but not identical. Thus a first track section including only co-operating formations of the first type at both its respective ends may be joined to adjacent track sections provided that the respective adjacent track section has co-operating formations of the second type at the end to be joined. For example, in the completed track, track sections 10 having exclusively co-operating formations of the first type may alternate with track sections 10 having exclusively co-operating formations of the second type.

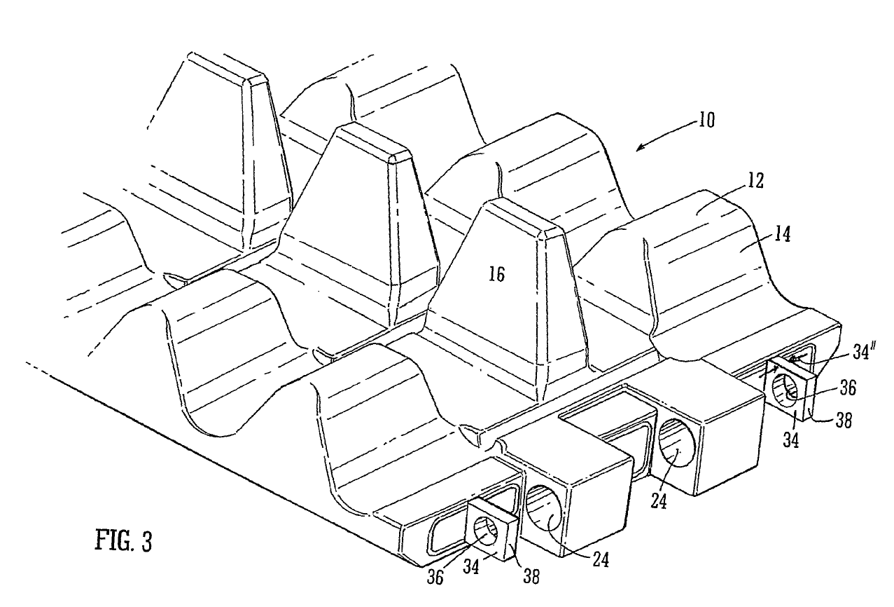

As can be seen in particular from FIGS. 3 and 4, one of the two types of co-operating formation (identified here for convenience as the first type) comprises a projecting finger or lug 34 which extends longitudinally forwardly of the adjacent anchor member 20. Most preferably, the projecting finger is fixedly attached to the adjacent anchor member 20. In the preferred embodiment as illustrated, the projecting finger is an integral part of the unitary body 30.

Thus, in the preferred construction as illustrated the unitary body 30 includes the co-operating formation of the first type. The unitary body 31 includes the co-operating formation of the second type. It is thus apparent that in the preferred construction as illustrated, the track section 10 includes two complementary unitary bodies 30, 31 arranged respectively at opposed ends of the track section 10.

Each projecting finger 34 includes a through bore 36 which is coaxial with the through bores 24 of the track pin receiving elements 26 of the unitary body 30. The through bore 36 also accommodates the track pin 22 when like track sections 10 are joined together. The projecting finger 34 comprises a forward substantially planar face 38 which forms an abutment surface for co-operation with the co-operating formation of the second type.

FIG. 2A illustrates the co-operating formation of the second type. In FIG. 2A, the unitary body 31 includes two track pin receiving elements 26′ which are spaced apart by a gap 34′. The gap 34′ has a width which is slightly greater than the width 34″ of the projecting finger 34 whereby the projecting finger 34 may be inserted into the gap 34′. The connecting web 32′ by which the track pin receiving elements 26′ are joined to the anchor member 20 defines a short recess 32″ including a substantially planar rear face 38′. The rear face 38′ forms an abutment surface which co-operates with the forward face 38 of the projecting finger 34. Thus, when the joint between adjacent track sections 10 is assembled, the faces 38, 38′ are juxtaposed, that is, the faces are in confronting relation. Most preferably, the projecting finger 34 and the recess 32″ are sized so that the faces 38 and 38′ lie against one another. FIG. 2A shows the above arrangement at the left hand side of the track section 10 as shown. It will be understood that a corresponding arrangement is provided at the other side of the track section 10, encapsulated within the area of the formation 14′. The projecting finger 34 is shown as having a single abutment surface 38 which co-operates with a corresponding single abutment surface 38′ of the recess 32″. It is, however within the scope of the invention for the projecting finger 34 to include more than one abutment surface 38 and correspondingly for the recess 32″ to include more than one abutment surface 38′, provided only that the respective surfaces are shaped to conform and to ensure that rotation of the joined track sections 10 about the track pin 22 is substantially prevented.

Thus the invention provides track sections 10 which may easily and quickly assembled into a vehicle track, and, where required, may be easily and quickly removed from the track for repair or maintenance or replacement without the use of specialist or complex tools. By ensuring that the joint between the track sections is substantially rigid, the joint is not required to accommodate torsional loads. The resulting track is light in weight, has low noise generation and a low Radar signature. The track also generates relatively low levels of vibrations and can be used on conventional running gear (of the vehicle) with only minor modification of the vehicle.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A track for a track laying vehicle comprising a plurality of track sections joined together at substantially rigid joints formed between the adjacent track sections, each track section comprising:
(i) an intermediate relatively flexible portion;
(ii) one or more first joining portions attached at one end of the track section and one or more second joining portions attached at the other end of the track section; and
(iii) co-operating formations of a first type or a second type arranged at respective ends of the track section,
wherein in the substantially rigid joint:
(a) the joining portions of the adjacent track sections are arranged in a predetermined mutual joining configuration; and
(b) the co-operating formations of the first and second types arranged respectively on the adjacent track sections co-operate substantially to prevent rotation of a given track section end with respect to the track section end to which it is attached.

2. A track section adapted to be joined to like track sections by means of substantially rigid joints to form a track for a track laying vehicle, the track section comprising:
(i) an intermediate relatively flexible portion;
(ii) one or more first joining portions attached to the track section at one end thereof and one or more second joining portions attached to the track section at the other end thereof,
(iii) operatively co-operating formations of a first type or a second type arranged at respective ends of the track section,
wherein the respective first and second joining portions and the co-operating formations are so arranged that, when, operatively, the track section is joined to an adjacent like track section:
the joining portions of the joined track sections are arranged in a predetermined mutual joining configuration; and
co-operating formations of the first or second type are arranged to cooperate with respective co-operating formations of the second or first type of the adjacent like track section substantially to prevent rotation of a given track section end with respect to the track section end to which it is attached.

3. A track as claimed in claim 1 wherein the one or more joining portions comprise one or more track pin retaining elements, each track pin retaining element comprising a through bore, the bores of the track pin retaining elements at the respective ends being substantially coaxial, wherein in the substantially rigid joints formed between the adjacent track sections the track pin retaining elements of the adjacent track sections are so arranged that the through bores are coaxial and a track pin is disposed through the bores of each joint.

4. A track section as claimed in claim 2 wherein the one or more joining portions comprise track pin retaining elements, each track pin retaining element comprising a through bore, the track pin retaining elements being so arranged that, when operatively the track section is joined to an adjacent like track section, the through bores of the track pin retaining elements are coaxial.

5. A track as claimed in claim 1 wherein the relatively flexible intermediate portion comprises:
(i) an inner face and an outer face, the outer face operatively contacting the ground; and
(ii) one or more tension elements arranged within the track section and extending longitudinally of the track section;
and wherein one or more tension element attachment formations are arranged proximate the respective ends of the track section, to which the, or each, tension element is attached whereby tensile loads are operatively transferred between the tension elements and the joining portions.

6. A track as claimed in claim 5 wherein the, or each, tension element comprises a wire or cable.

7. A track as claimed in claim 5 wherein the, or each, tension element comprises a longitudinally extensive web of fabric.

8. A track as claimed in claim 5 wherein the inner and outer surfaces of the track section comprise material selected from rubber, synthetic rubber, rubber or synthetic rubber composite material, and rubber like compositions and the, or each, tension element is substantially encapsulated in said material.

9. A track as claimed in claim 5, wherein the tension element attachment formations comprise one or more of:
outer surfaces of the joining portions; and
one or more anchor members attached to the joining portions at respective ends of the track section.

10. A track as claimed in claim 9 wherein the joining portions are track pin retaining elements.

11. A track as claimed in claim 9 wherein the anchor members comprise rod-like portions to which the tension elements are attached.

12. A track as claimed in claim 11 wherein the rod-like portions are substantially co-linear.

13. A track as claimed in claim 11 wherein the joining portions are track pin retaining elements.

14. A track as claimed in claim 13 wherein the rod-like portions are arranged substantially parallel to the axis of the through bore of the, or each, track pin retaining element.

15. A track as claim in claim 13 wherein the anchor members are fixedly attached to adjacent track pin retaining elements.

16. A track as claimed in claim 15 wherein the track pin retaining elements are attached to an adjacent anchor member by means of one or more connecting webs, whereby the track pin retaining elements and the anchor members are arranged in spaced apart relation.

17. A track as claimed in claim 9, wherein the formation of the first type is fixedly attached to an adjacent anchor member.

18. A track as claimed in claim 17 wherein the formation of the first type is formed integrally with an adjacent anchor member.

19. A track as claimed in claim 9, wherein each respective end of the track section comprises a unitary body which body includes both the anchor member and the joining portions.

20. A track as claimed in claim 19 wherein the unitary body at a first end of the track section further includes at least one co-operating formation of the first type.

21. A track as claimed in claim 19 wherein the unitary body at a second end of the track section further includes at least one co-operating formation of the second type.

22. A track as claimed in claim 1 wherein the co-operating formations of the first type include an abutment surface which, on operatively forming said joint, is juxtaposed against a complementary abutment surface of a co-operating formation of the second type thereby to prevent said rotation.

23. A track as claimed in claim 22 wherein the co-operating formation of the first type comprises a longitudinally projecting finger.

24. A track as claimed in claim 23 wherein the abutment surface comprises a leading end surface of said finger.

25. A track as claimed in claim 24 wherein said abutment surface is substantially planar.

26. A track as claimed in claim 23, wherein the joining portions comprise track pin retaining elements and wherein the co-operating formation of the first type includes a through bore which is coaxial with the through bore of the track pin retaining elements and is sized operatively to accommodate a track pin.

27. A track as claimed in claim 16, wherein the co-operating formations of the first type include an abutment surface which, on operatively forming said joint, is juxtaposed against a complementary abutment surface of a co-operating formation of the second type thereby to prevent said rotation, and wherein said complementary abutment surface is formed in a said connecting web.

28. (canceled)

29. A vehicle having a track as claimed in claim 1.

30. A vehicle having a track comprising track sections as claimed in claim 2.

31. A track section as claimed in claim 2, wherein the relatively flexible intermediate portion comprises:
(i) an inner face and an outer face, the outer face operatively contacting the ground; and
(ii) one or more tension elements arranged within the track section and extending longitudinally of the track section;
and wherein one or more tension element attachment formations are arranged proximate the respective ends of the track section, to which the, or each, tension element is attached whereby tensile loads are operatively transferred between the tension elements and the joining portions.

32. A track section as claimed in claim 2, wherein the co-operating formations of the first type include an abutment surface which, on operatively forming said joint, is juxtaposed against a complementary abutment surface of a co-operating formation of the second type thereby to prevent said rotation.
